(19) United States
(12) Patent Application Publication
(10) Pub. No.: US 2007/0229894 A1
(43) Pub. Date: Oct. 4, 2007

(54) Method and System for Processing Print Data of at Least One Print Page

(76) Inventors: Rudlger Siemens, Munchen (DE); Andreas Bolsch, Markt Schwaben (DE); Herbert Hundsnurscher, Worth (DE); Olga Kurmann, Munchen (DE); Helmut Weiner, Muchen (DE)

Correspondence Address: SCHIFF HARDIN, LLP;PATENT DEPARTMENT, 6600 SEARS TOWER, CHICAGO, IL, 60606-6473, US

(21) Appl. No.: 10/581,502

(22) PCT Filed: Dec. 9, 2004
(86) PCT No.: PCT/EP04/14042

§ 371 Date: Feb. 21, 2007

(30) Foreign Application Priority Data
Dec. 9, 2003 (DE) 103 57 490.5

(51) Int. Cl. G06K 15/00

(52) U.S. Cl. 358/1.16

(57) ABSTRACT

In a method or system for processing of print data, a print data stream with print data of a plurality of print pages is generated wherein at least one first object property is associated with at least one region of the print pages. The print data are processed wherein at least one part of the at least one region of one of the plurality of print pages of the print data stream is selected. At least one second object property differing from the at least one first object property is associated with the selected part of the region on each of said plurality of print pages of the print data stream. The print data of each of said plurality of print pages which pertain to the selected part of the region are further processed dependent on the at least one second object property.

### BACKGROUND

The preferred embodiment concerns a method and a system for processing of print data of at least one print page. A print data stream with print data of a print page is generated, whereby first object properties are associated with at least one region of this print page. These object properties concern in particular image properties and/or image processing parameters that are associated with this region.

Print data are supplied to a print center in the form of a print data stream for generation of printed matter. The print data are often prepared such that the print images are essentially no longer modifiable. In various types of printed matters it is also absolutely necessary for security and data protection reasons that the objects to be shown (such as text or business graphics) are no longer modifiable. This is in particular absolutely necessary given account statements and bills in order to primarily preclude manipulations and errors in the content of these documents via incidents in the print center. However, the processing of print data requires a differentiated processing of the print data of individual objects of a print page in order to select suitable processing parameters with the help of which the respective objects are then optimally adapted to the output parameters of the printer in order to ensure high-quality print images via suitable image conversion methods or image processing methods. However, in the print data streams the individual objects often have identical object properties, whereby a differentiated processing of the individual objects is not possible. The transferred print data are thus identical with regard to determined attributes.

Methods and systems are known from the patent application WO-A-01/77805 (by the applicant) for creation and output of at least one print page in which object properties are associated with individual objects of the print page upon generation of the print page, with the aid of which object properties a selection of processing methods are selected for generation of a print image.

From WO 03/025713 A a method is known in which a printed document is scanned in with the aid of a scanner and digitized into image data. The digitized image data are individually analyzed per document and per page by operating personnel. Attributes (for example text or image) are then associated with various regions of the recorded document (such as, for example, images or text present there) by operating personnel.

A device for modification of a document is known from the document EP-A-1 133 159, in which rectangular regions with which property parameters are already associated are automatically extracted in a document. An operating personnel can establish and associate the type of the modification of the selected rectangular regions. This type of modification that is associated with a rectangular region is stored associated with the region. The data of the region are processed dependent on the associated type of the modification and output as a modified image.

A printer controller as well as a method for controlling a printer is known from the document JP 10 105348 A, in which attributes are associated per page with the objects to be printed. These attributes pertain to the resolution of the page to be printed. The processing resolution in the processing of the corresponding page is changed dependent on a resolution associated with a page.

From the document JP 11 196285 A it is known to establish the conditions for processing in a simple manner, in that images with different color processing conditions are output in parallel in order to enable a simple selection possibility of the color processing conditions for the user.

From the document US 2002/057443 A1 it is known to add attribute information to print data that are transferred from a printer driver to a printer on the basis of color information of the colors C, M, Y, K. The printer driver establishes a corresponding value dependent on the color information and sends the print data to the printer. The printer prints print images corresponding to the print data dependent on the transmitted attribute.

### SUMMARY

It is an object to specify a method and a system for processing of print data of at least one print page, via which method and system print data with which high-quality print images can be generated are provided in a simple manner.

In a method or system for processing of print data, a print data stream with print data of a plurality of print pages is generated wherein at least one first object property is associated with at least one region of the print pages. The print data are processed wherein at least one part of the at least one region of one of the plurality of print pages of the print data stream is selected. At least one second object property differing from the at least one first object property is associated with the selected part of the region on each of said plurality of print pages of the print data stream. The print data of each of said plurality of print pages which pertain to the selected part of the region are further processed dependent on the at least one second object property.

### BRIEF DESCRIPTION OF THE DRAWINGS

FIG. 1 is a system according to a first embodiment of the invention for generation and output of a print page;

FIG. 2 is a block diagram with elements for generation of a print page;

FIG. 3 is the view of a print page that has been generated with the aid of the system according to FIG. 1;

FIG. 4 is a block diagram of a workflow for generation and output of a print page according to FIG. 3 according to an embodiment of the invention;

FIG. 5 shows the comparison of an original image contained in a print data stream with the aid of a pattern dithering method in a black-and-white image;

FIG. 6 is a conversion of the original image according to FIG. 5 in a black-and-white image with the aid of a diffusion dithering method;

FIG. 7 is a conversion of the original image according to FIGS. 5 and 6 into a black-and-white image with the aid of a halftone screen method;

FIG. 8 shows the conversion of the original image according to FIGS. 5 through 7 into a black-and-white image with the aid of a regular raster method;

FIG. 9 shows the conversion of the original image into a black-and-white image with the aid of an error diffusion method according to Floyd-Steinberg;

FIG. 10 shows the conversion of the original image into a black-and-white image with the aid of an error diffusion method according to Bukes;

FIG. 11 shows the conversion of the original image into a black-and-white image with the aid of an error diffusion method according to Stucki; and

FIG. 12 shows a workflow plan for implementation of a method for processing of print data of at least one print page according to an embodiment of the invention.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

Via a method of the preferred embodiment for processing of print data of at least one print page, it is possible to execute different predetermined image processing processes within one page for the part of the region and the remaining region. For example, it can be provided to select a predetermined rastering and/or a predetermined color conversion within specific regions of a page with the aid of the object properties. An optimal processing of the document data, i.e. the print data contained in the print data stream for generation of at least one print page, is thereby also implemented when no individualizing object properties with which an automatic selection of image processing processes is possible are assigned to the individual objects contained in the print data stream. An optimal image processing of the transferred print data is thus also possible when the per-object associations of object properties have been lost or have been intentionally removed in the transfer from the originator up to the delivery to the print center. However, a differentiation capability that is enabled by the method of the preferred embodiment is necessary for an optimized further processing of the corresponding objects.

A second aspect of the preferred embodiment concerns a system for processing of print data of at least one print page. A print data stream with print data of one print page is generated with the aid of a first data processing unit, whereby first object properties are associated with at least one region of this print page. A second data processing unit processes the print data, whereby at least one part of the region can be selected. At least one second object property varying from the first object properties are associated with at least one region of this print page. A second data processing unit processes the print data, whereby at least one part of the region can be selected. At least one second object property varying from the first object property can be associated with this selected portion of the region. The second data processing unit processes the print data that pertain to the selected part of the region further depending on the second object property.

Via the system according to the second aspect of the preferred embodiment it is possible to also individually further-process print data of different objects when the print data of the objects themselves contain no individualizing object properties. The further processing of the print data can be implemented via the system of the preferred embodiment with image processing methods suitable for these print data, whereby the print data can in particular be further processed for generation of print images such that optimal print images are generated.

A third aspect of the preferred embodiment concerns a system for processing of print data of at least one print page. A print data stream with first print data of a print page is generated with the aid of a first data processing unit. First object properties are associated with at least one region of this print page. A second data processing unit processes the print data, whereby at least one part of the region is selectable. At least one second object property varying from the first object property can be associated with this selected part of the region. A printer further processes the print data that pertain to the selected portion of the region, at least dependent on the second object property.

Via the system according to the third aspect of the preferred embodiment, it is achieved that print data are supplied to the printer, in which print data individualized object properties can be associated with the objects contained therein. The processing of the data of these objects can then be individually processed by the printer with the aid of suitable image processing methods, whereby at least one of the image processing methods is selected and/or parameterized with the aid of the associated second object property. The object property is assigned to an object in that a planar portion of a region of a print image or a portion of a print image is selected with which at least one individualized object property is assigned. This planar portion or partial region can thereby be further processed differently than the remaining region of the print page with originally-identical object properties or differently than the remaining print page with originally-identical object properties. Each object can thereby be processed with the aid of a plurality of different image processing methods in order to achieve a processing of the print data suitable for generation of a qualitatively high-grade print image.

A fourth aspect of the preferred embodiment concerns a method for processing of print data of at least one print page, in which method a print data stream with print data of a print page is generated, whereby first object properties are associated with at least one region of this print page. The print data are processed, whereby image data of the region are determined with which a preset graphic format is associated. The image data are processed further dependent on the preset graphic format. Via this method it is achieved that the image data with which the preset graphic format is associated are converted or adapted, for example with the aid of different image processing procedures than the remaining print data of the region. In particular graphics and images can thereby be optimally adapted to the output parameters of a printer that should generate a print image on a substrate material with the aid of the print data.

A fifth aspect of the preferred embodiment concerns a system for processing of print data of at least one print page, in that a print data stream with print data of a print page is generated with the aid of a first data processing unit, whereby at least one first object property is associated with at least one region of this print page. The system has a second data processing unit that processes the print data, whereby the data processing unit determines image data of objects of the region with which a preset graphic format is assigned. The second data processing unit processes the image data further dependent on the preset graphic format. Via this system the image data with which the preset graphic format is associated can be processed individually and dependent on the remaining print data for generation of the print image of the region. These image data are advantageously individually adapted to the output parameters of the printer. The region advantageously comprises: a part of the print page; one print page; a plurality of print pages; in particular a complete document.

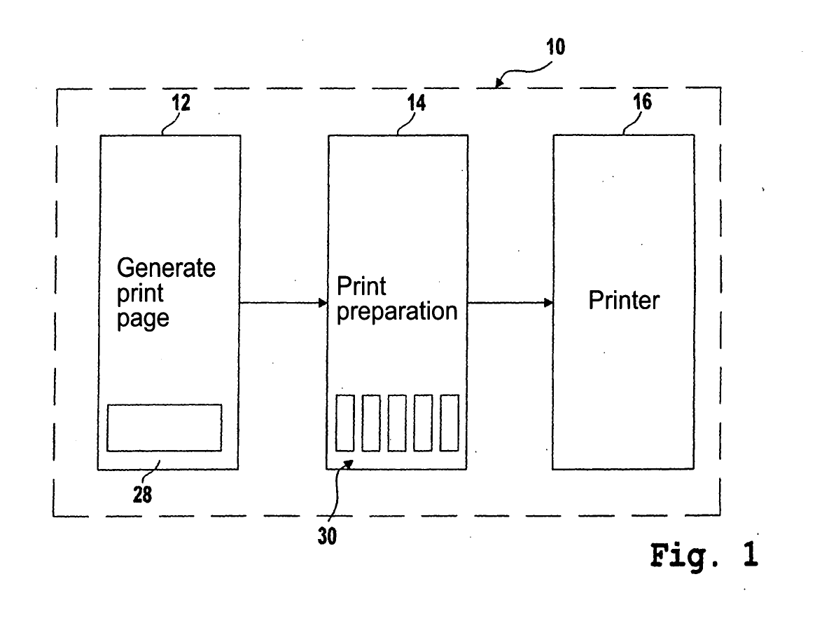

The workflow for generation and output of a print page in a typical production workflow given the generation of documents is shown in FIG. 1 with the aid of a block diagram of a system 10. With the aid of a first data processing system 12, a print page is created with the aid of a suitable program 28. Such a program can, for example, be “Quark Express”, Microsoft Word” or the program “Photoshop” by the company Adobe. In order to prevent manipulations of the generated print data, the print page is output in the form of a print data stream 28 that can no longer be manipulated. Such a print data stream can, for example, be generated with the aid of a portable document format (pdf) by the company Adobe. This print data stream is transferred to a second data processing unit 14. With the aid of the second data processing unit 14, a print preparation occurs in which the print data contained in the print data stream are adapted to the output parameters of a printer 16 to which the print data are supplied for generation of a print image on a substrate material. With the aid of the system 10, print data of at least one print page are thus generated, processed and supplied to the printer 16 for generation of a print image.

The program 28 executed with the aid of the data processing system 12 for generation of the print page is also designated as a form editor program module. The print data of the print page are thereby generated independent of the output apparatus 16 on which this print page is output at a later point in time. The second data processing unit 14 is also designated as a print preparation computer and comprises a plurality of program modules for execution of image processing procedures 30 that are executed together with further program modules (not shown) by the print preparation computer. With the aid of an input unit (not shown) of the print preparation computer 14, an operating personnel gives the instruction to output the print page on the printer 16. The print data of the print data stream are thereupon adapted to the output parameters of the printer with the aid of the image processing procedures 30.

However, the print data transferred from the first data processing system 12 to the second data processing system 14 comprise no individualizing object properties of individual objects of the print page, such that the image processing procedures 30 cannot be executed adapted to the respective object and/or such that the selection of a suitable image processing procedure 30 cannot occur with the aid of such an object property. According to the preferred embodiment, the print page is shown on a display unit with the aid of the data processing system 14, and an operating personnel has the possibility to mark individual sub-regions of the print page via input of coordinates and/or with the aid of a pointer device and to assign an object property to such a selected sub-region, with which object property a suitable image processing procedure 30 and/or parameters of such an image processing procedure 30 are established given a further processing of these print data. The operating personnel can thereby also mark a plurality of sub-regions of the print page with which she respectively assigns an object property suitable to the object contained in this sub-region. An object property is thus assigned to print data that serve for generation of the print image of the selected part. Alternatively or additionally, objects that have an individualizing object property in the print data stream (such as, for example, graphic objects in a graphic format, in particular the BMP, JPEG and TIFF format) are processed dependent on this object property. These objects then do not have to be selected and established via a selection of a sub-region of a page.

If print data of a plurality of print pages are comprised in the print data stream, the operating personnel can individually determine sub-regions on each print page and assign object properties to these sub-regions, and can alternatively designate at least one sub-region to which the same object property is then assigned on every page. This is in particular reasonable when the document to be printed contains a predetermined object (such as, for example, a company logo) at the same position on every page.

In this exemplary embodiment, the print data have been generated in full color with a resolution of 800 dpi with the aid of the data processing unit 12. However, the printer 16 can output only print images with a resolution of 300 dpi in black and white. An adaptation of the print data to the output of the printer 16 must thus occur. For this, objects that are contained in the print data in a different color than the reproduction color of the printer must be converted into the print color of the printer 16.

The output color of the printer 16 is black, such that colored elements are output with the aid of a black-and-white representation. The conversion from color and/or greyscale representations into a black-and-white representation occurs with the aid of what are known as dithering image processing methods. With the aid of these dithering methods, grey tones and combination colors are converted into a raster image with two basic colors, advantageously black and the color of the substrate material (i.e., for example, white). In contrast to the rastering, i.e. to the pure adaptation of the resolution, in the dithering method all image points are equally large. With the aid of the dithering method, additional grey levels or colors are generated in a purely calculational manner in image representations in order to generate continuous color and/or brightness transitions.

Dithering methods utilize the manner of perception of the human eye via which distinct color points placed at very small intervals next to one another are no longer perceived as individual colors, but rather as combination colors. If only black and white are used as colors, as in the printer 16, the perception for the observer is a grey surface. The dithering method can proceed technically as follows. The image to be altered is analyzed line-by-line from the left upper corner to the left lower corner, whereby an area of 2×2 pixels is respectively examined as a raster size, whereby the average grey value of this raster size is determined. Given color images, an average color tone is correspondingly determined. Depending on whether this value lies above or below a comparison threshold (which can be set in advance), either the color black or white is assigned to the pixels of the raster size. A raster field shifted by one pixel is subsequently analyzed and, as described, a uniform color value is determined. This procedure is continued until the entire surface of the image is processed.

In other dithering methods, the raster size of the raster units is enlarged and a redistribution of the pixels is effected within the raster. 17 different grey levels can then be represented in a 4×4 pixel raster. The number of the possible grey levels is the number of the image points contained in this raster unit plus one. To avoid unwanted patterns (such as stripes and waves) in the dithered image, in other dithering methods algorithms are used that randomly distribute the image points to be inked. Both reductions of the colors and grey levels of an image and reductions of the resolution can thus be generated with the aid of dithering methods.

However, given some objects contained on the print page (such as, for example, vector graphics, text elements and some business graphics) the use of a dithering method that is, for example, suitable for conversion of portrait photos does not lead to qualitatively high-grade print images since at least some of the smooth edges of the image elements would only be shown blurry via this dithering method.

However, given a print data stream with essentially identical object properties of the objects no automatic differentiation for selection of a suitable processing method or conversion method is possible, whereby only uniform processing parameters can be preset in the prior art.

In contrast to this, according to the preferred embodiment it is possible to mark individual sub-regions of a print page and to then assign an individual object property to this marked region, with which object property a suitable post- or further-processing can occur. Alternatively, graphic objects that are contained in a predetermined graphic format in the print data stream are further processed dependent on this graphic format, in particular with the aid of a suitable image processing procedure. The image processing procedure for processing of these entire objects is thus selected dependent on the graphic format of the object. Furthermore, according to the preferred embodiment sub-regions can be selected for the further regions of a print page to be generated or a document to be generated in order to assign special object properties to these sub-regions.

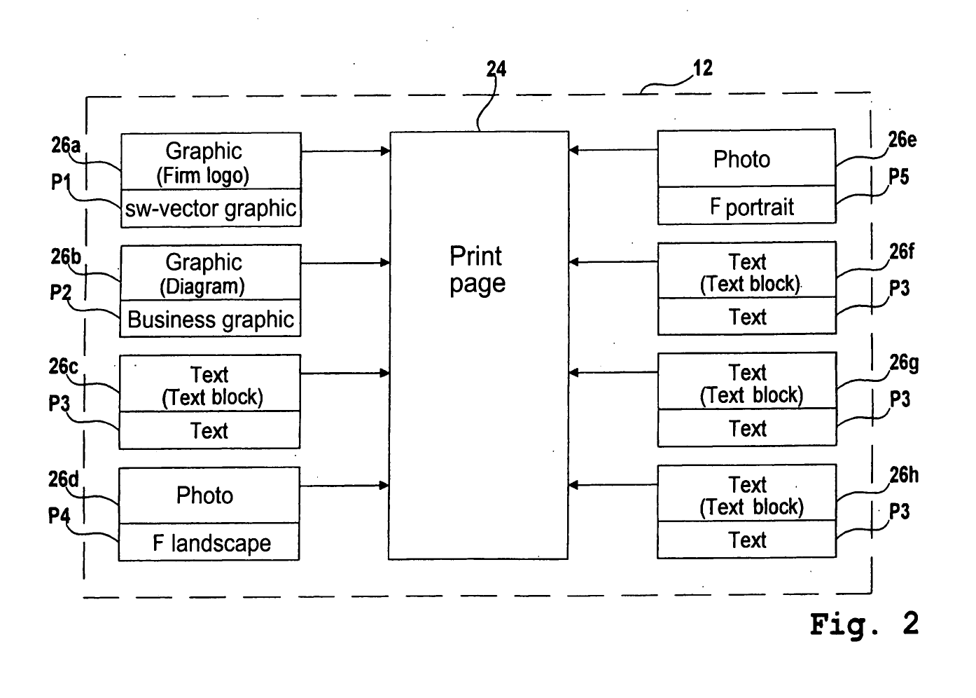

In FIG. 2 it is schematically shown how a print page 24 is generated by an operating personnel with the aid of the first data processing system 12. The blocks 26a through 26h, which are generally designated in the following with 26, are inserted into the print page 24 by the operating personnel and positioned at a suitable location. The print page 24 is thereby a region to be processed, and an individual block 26 is a part of this region 24 to be processed.

The data of the blocks 26 are loaded from data sources (not shown) or generated by the operating personnel with the aid of functions contained in the form generator program module 28. The loaded blocks 26 are adapted with further functions of the form generator program module 28 corresponding to the presets of the operating personnel, in particular in shape and size, and arranged at the desired position on the print page 24. The block 26a thus comprises a black-and-white vector graphic; the block 26b comprises a diagram with a business graphic; the blocks 26c, 26f, 26g, 26h contain text; whereby the block 26c comprises text in the color black; the block 26f comprises text in a red color; the block 26g comprises text in a grey level representation; and the block 26h comprises text in the color black. A block 26d and a block 26e respectively comprise a color photo, whereby the photo of the block 26d comprises a landscape image and the block 26e comprises a portrait image. The object properties of the blocks 26 are designated with P1 through P5 in FIG. 2.

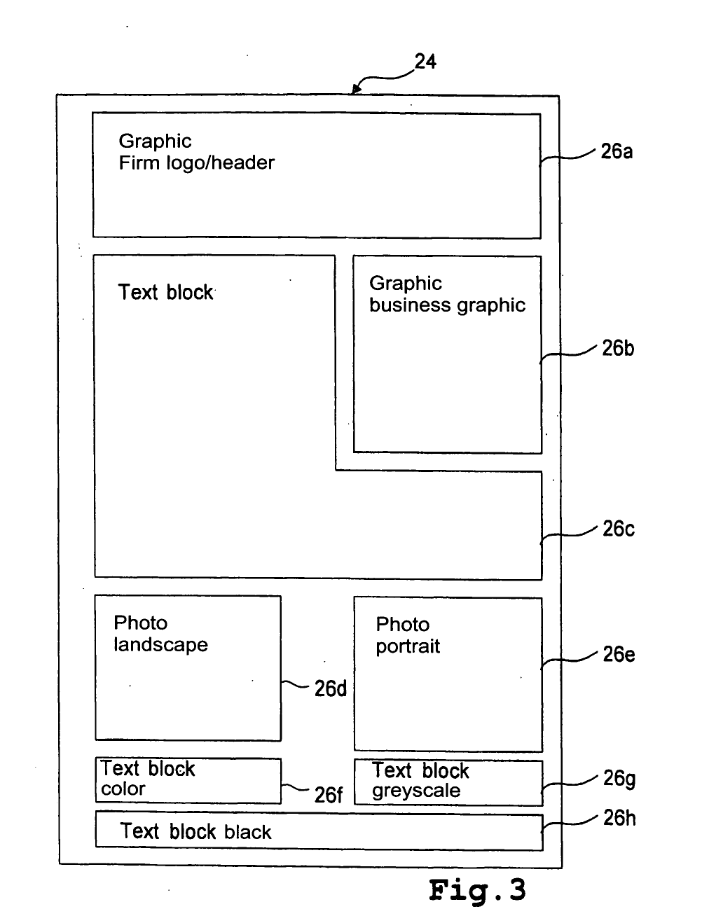

The arrangement of the blocks 26a through 26h on the print page 24 with the aid of rectangles is exemplarily shown in FIG. 3. However, the shape of the blocks is not limited to a rectangle; rather, they can have an arbitrary shape. The outlines of the blocks can also be circular or arbitrarily-shaped polygons.

The print data of the print page 24 that was generated with the aid of the first data processing system 12 are transferred to the second data processing system 14 in the system 10 according to FIG. 1. However, no individualizing object properties of the individual blocks 26a through 26h are comprised in the print data, such that no individual selection and/or adaptation of at least one image processing method for individual objects can occur given a further processing of the print data in the second data processing system 14. Rather, the individual objects of the blocks 26a through 26h can no longer be differentiated as objects. The print data of the print page 24 thus advantageously comprise only pixel data of individual image points of the print page 24. An individual optimized further processing with the aid of the data processing system 14 is thus not possible without further techniques. The printer 16 can also thereby not differentiate individual objects of the print page 24.

According to the preferred embodiment it is provided that individual sub-regions of the print page 24 are established by an operating personnel via a selection with the aid of the second data processing system 14. The selection advantageously occurs via output of the print image of the print page on a display unit of the data processing system 14 and marking of the selected region with the aid of a pointer device or a keyboard. The operating personnel assigns at least one individualizing object property with the selected sub-regions. With the aid of this individualizing object property, the print data associated with this region are adapted to the output parameters of the printer 16 with a suitable image processing method and subsequently output by the printer 16. The adaptation to the output parameters of the printer 16 occurs with the aid of the second data processing unit 14 or alternatively with a data processing unit of the printer 16. The adaptation of the print data to the output parameters of the printer as well as to further parameters (such as, for example, to the printer language, the type and hardness of the fixing rollers, the type and the properties of the substrate material) and to the color settings (i.e. to the color management) of the printer 16 thereby occurs.

Objects (such as, for example, logos in vector graphics, vector graphic text elements and similar objects) can thereby be selected and, for example, not dithered, whereas other objects such as photos can furthermore be dithered. The conversion of multi-colored elements into two-color or three-color elements can also specifically be controlled and optimized with the aid of parameters and/or image processing methods that can be preset. The print image can thereby be optimally adapted to the output parameters of the printer. This is in particular advantageous when the printer can generate print images in the color black and a further color, for example the color red. This generation of two print images of different colors is also designated as highlight color printing. The conversion of colored objects in colors different than the print colors of the printer into the print colors of the printer is also designated as color preparation. The conversion with the aid of such a color preparation method can thereby occur dependent on the object properties assigned to the object.

For example, a predetermined rastering and/or a predetermined color conversion within specific regions of a page can also be provided. The overfilling of objects is used in trapping methods. The algorithms thereby used can occur dependent on the object properties assigned to the object. An optimal processing of the document data or of the print data that are generated by the first data processing unit 12 occurs via the inventive assignment of the image properties for regions of the print page 24 to be established. This is also possible when no individualizing object properties are associated with the objects or these object properties have been lost in the transfer from the first data processing unit 12 to the second data processing unit 14 or even when the individualizing object properties have been subsequently removed. This removal in particular occurs when print data (in particular billing data) are transferred from an organization to a print center and manipulations or an incorrect processing of the data should be precluded. However, an individual association of image processing methods with individual objects is then also no longer possible without further techniques.

The image processing methods in particular produce: an edge smoothing; the soft-focus effect; the sharp-focus effect; the brightness; the contrast; the negative representation; the mirroring; the resolution; the color representation; limit values for color conversion; the watermark representation of the individual objects of the print page 24. A position-dependent control of the image processing of the respective page region that can be limited to multiple different regions of a page and individually determined for different print pages is possible, in particular for reduction of full color representations, whereby image processing methods and algorithms used as well as their parameterization are designed and established. The reproduction quality of the individual objects in the print image generated with the aid of the printer 16 is thereby significantly improved. In particular the use of two different toner colors, for example the toner color black and the toner color red, can only be reasonably employed given such a per-object processing. However, often upon generation of the print page 24 it is not established which output parameters the printer 16 has (on which printer 16 the print page 24 should be output at a later point in time). A full color image of an object is thereby advantageously integrated into the print data stream, and only after the output parameters (in particular the possible printable colors) are established is this full color image converted and advantageously optimally adapted to the output parameters of the printer with the aid of a suitable image processing procedure. Given objects with further object properties in the print data stream (such as, for example, a data format, in particular a graphic data format), alternatively or additionally the type of the graphic format or information that can be determined with the aid of the graphic format can be used for the selection of a processing procedure for adaptation of the respective object to the output properties of the printer. This information can, for example, be contained in header data of JPEG graphic objects of the TIFF graphic objects. An optimization of the adaptation of the objects thus occurs via the processing of the print data with the aid of the second data processing system 14 and/or via assignment of individualized object properties to a part of the print page 24.

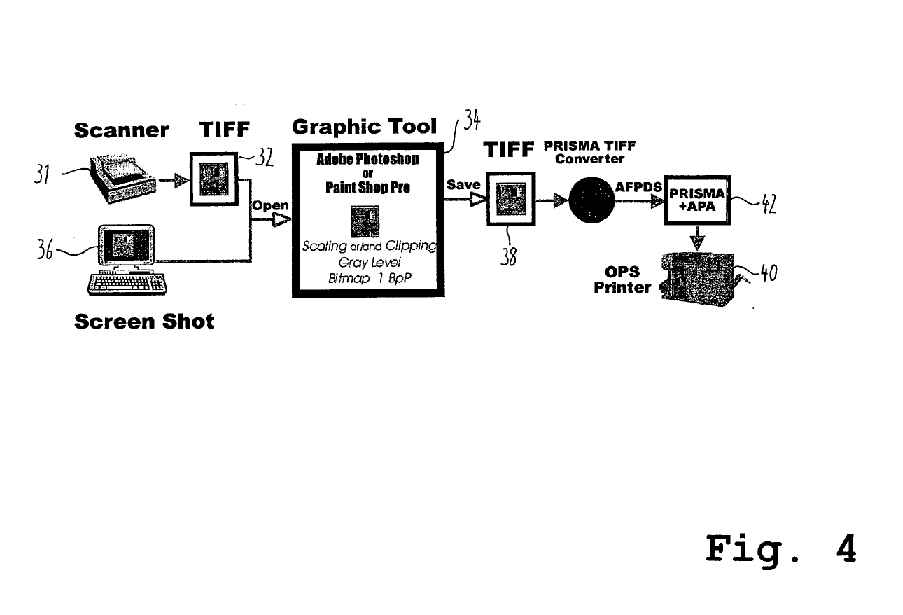

A block diagram is shown in FIG. 4 that shows the workflow for generation and output of a print page 24 according to the preferred embodiment. Image data 32 in a TIFF data format are generated with the aid of a scanner 31 and supplied to a program module 34 of a second data processing system. Alternatively, image data are generated with the aid of a personal computer 36, for example generated via acquisition of a current display image of a display unit of the personal computer 36 and supplied to the program module 34. The program module 34 is an image processing program, for example the program Photoshop or the program Paintshop Pro by the company Adobe. Both the image data 32 and the image data transferred in the personal computer 36 have a color resolution of 32 bits per pixel and a resolution of 800 dpi. With the aid of the image processing program 34, these image data are converted into a black-and-white representation with a resolution of 96 dpi in order to adapt the image data to the output parameters of a printer 40. The image data 38 generated with the aid of the image processing program 34 are supplied to a print server 42 as an AFPDS print data stream. As is subsequently shown in FIGS. 5 through 11, the conversion of the image data 32 into image data 38 occurs with qualitatively different results with the aid of various image processing methods via the image processing program 34.

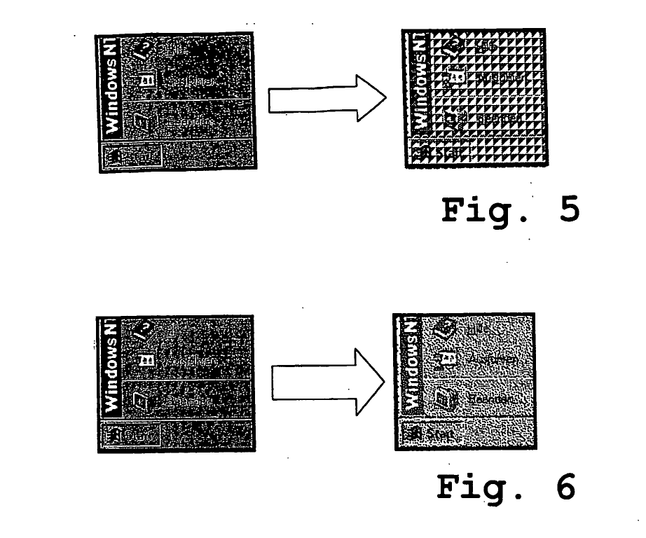

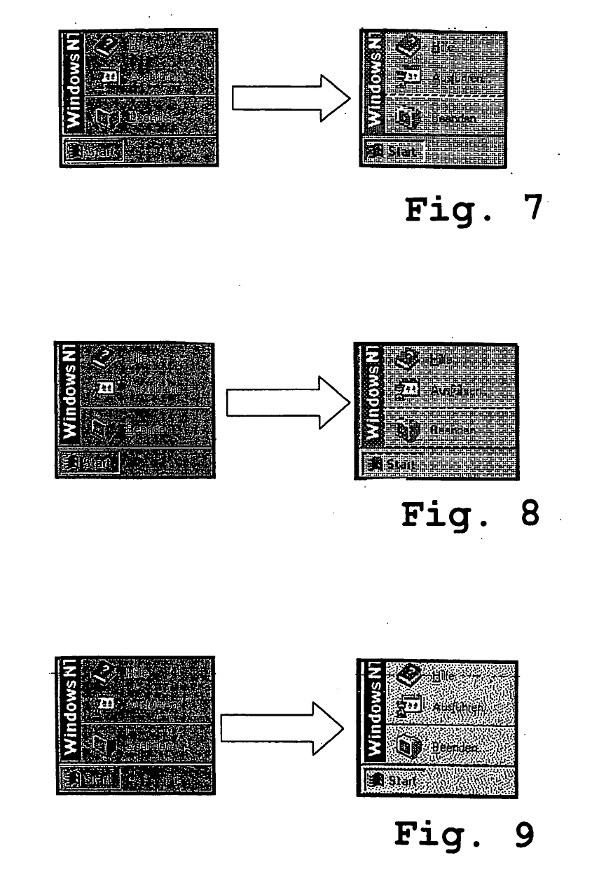

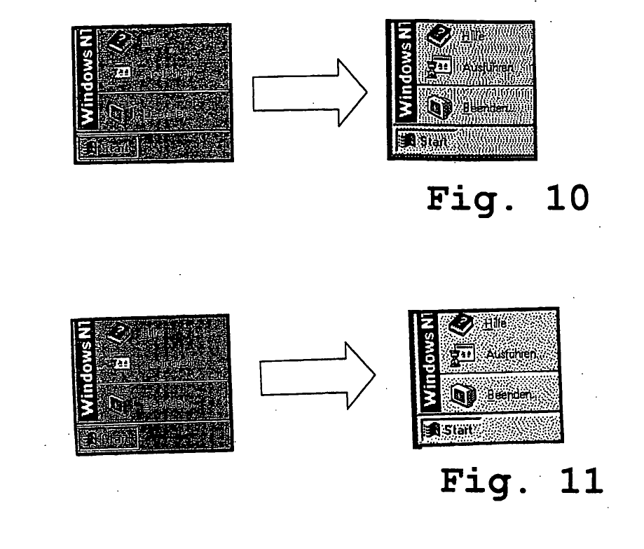

In FIGS. 5 through 11, the original image of the screen representation is respectively shown on the left side and the adapted image is respectively shown on the right side, whereby the conversion of the image data has occurred with the aid of different conversion methods or with various image processing methods. In FIG. 5 the conversion is with the aid of a pattern dithering method; in FIG. 6 the conversion is with the aid of a diffusion raster method; in FIG. 7 the conversion is with the aid of a halftone raster method; in FIG. 8 the conversion is with the aid of a regular raster method; in FIG. 9 the conversion is with the aid of an error diffusion method; in FIG. 10 the conversion is with the aid of an error diffusion method according to Brooks; and in FIG. 11 the conversion is with the aid of an error diffusion method according to Stucki. These error diffusion methods are generally also designated as raster methods. With the aid of the individualizing object properties assigned to the individual objects, a suitable conversion method (for example a conversion method according to FIGS. 5 through 11) can be selected depending on the object property in order to convert the print data of the region to which the respective object property is assigned with the aid of the selected image processing method. However, further image processing methods in addition to the image processing methods mentioned in FIGS. 5 through 11 can also be alternatively or additionally selected with the aid of the individualizing object properties, and/or their parameters can be established with the aid of the individualizing object properties. The object properties advantageously concern output, print and/or processing parameters. At least one object property serves for selection of a color conversion, raster conversion or color correction method.

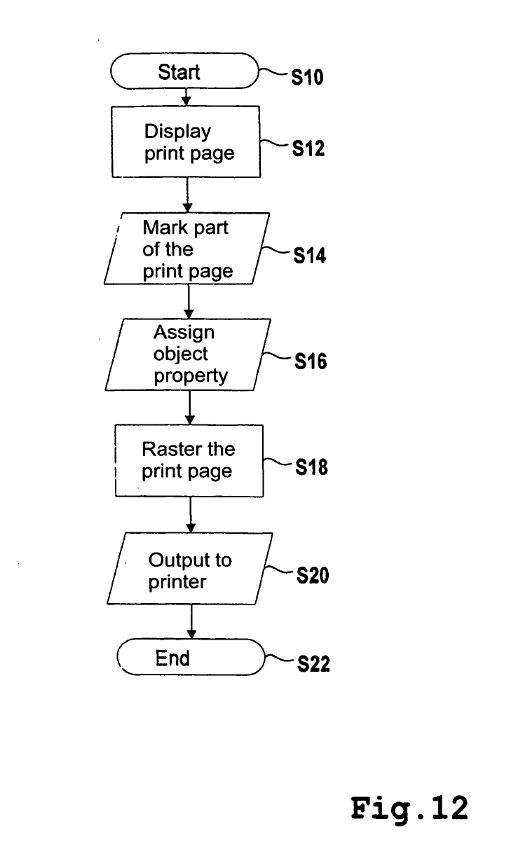

FIG. 12 is a workflow plan in which the workflow for association of individualized object properties according to an aspect of the preferred embodiment. The workflow is started in step S10. In step S12, the print page is subsequently displayed on a display unit of the second data processing unit. In a step S14, an operating personnel subsequently marks a part of the print page 24 and assigns an object property to this marked part of the print page 24 in the step S16, for example via assignment of an object parameter P1 through P5 (compare FIG. 2). The print data of the print page 24 in the step S18 are subsequently processed with the aid of a raster processor of the printer 16, whereby the print data associated with the marked portion are rastered and processed dependent on the object property P1 through P5 assigned in the step S16. With the aid of the raster image data generated in the rastering in the step S18, a print image is generated and output on a substrate material by the printer 16 in the step S20. the workflow is subsequently ended in step S22.

In a further aspect of the preferred embodiment, the assignment of an object parameter P1 through P5 alternatively occurs with the aid of a graphic format and/or image format of graphic or image data comprised in a data stream. Such graphic formats are in particular bitmap graphic formats such as, for example, GIF, TIFF, RKE, PNG, JPEG, IFF, TGA and BMP and vector graphic formats such as, for example, WMF, DXF and EPS. Further usable graphic formats are the PICT, STARTUP, MACPAINT, 9BPS, JFIF, PCX, SCR, IMG, RIFF, 8BIM, PICS, PIC, FLI, TGA, MSP, SHP, WPG, PBM, PGM, PPM, CGM, SUN, XBM, PM, PAC, DEGAS, TINY, NEOCHROME, SPC, GEM-META, IMAGIC, HP-GL, EPSF, EPSI, XWD and SUN-RASTER formats. Each of these graphic formats can itself be used as an object property and/or as a parameter for selection of a suitable image processing procedure for conversion of the image data associated with the respective graphic format.

Although preferred exemplary embodiments have been shown and described in detail in the drawings and in the specification, they should be viewed as purely exemplary and not as limiting the invention. It is noted that only the preferred exemplary embodiments are shown and described, and all variations and modifications that presently or in the future lie within the scope of protection of the invention should be protected.

1-25. (canceled)

26. A method for processing of print data, comprising the steps of:
generating a print data stream with data of a plurality of print pages wherein first object properties are associated with at least one region of the print pages;
processing the print data wherein at least one part of the at least one region of one of the plurality of print pages of the print data stream is selected;
associating at least one second object property differing from the first object properties with the selected part of the region on each of said plurality of print pages of the print data stream; and
further processing the print data of each of said plurality of print pages which pertain to the selected part of the region dependent on the at least one second object property.

27. A method according to claim 26 wherein a second print data stream is generated in which the at least one second object property is associated with the part of the region of each print page.

28. A method according to claim 27 wherein the second print data stream is supplied to a printer which processes the selected part of the region of each of the plurality of print pages dependent on the second object property or dependent on the second object property and at least one part of the first object property, and which processes the remaining region dependent on at least one part of the first object property.

29. A method according to claim 26 wherein the region comprises the entire print page.

30. A method according to claim 26 wherein the first and/or second object property pertains to at least one output, print, and/or processing parameter.

31. A method according to claim 26 wherein at least one object property serves for selection of a color conversion method, a raster conversion method, or an error correction method.

32. A method according to claim 31 wherein the raster method comprises a Floyd-Steinberg raster method, a Burkes raster method, or a Stucki raster method.

33. A method according to claim 26 wherein an areal region of the region is selected given the selection of the part of the region.

34. A method according to claim 33 wherein the areal region is selected with aid of geometric figures comprising at least one of rectangles, circles, or polygons.

35. A method according to claim 26 wherein an adaptation of a resolution of the print data contained in the print data stream to a resolution of the printer, and/or an adaptation of color and/or grey level values contained in the print data stream to device properties of the printer occurs in print preparation.

36. A system for processing of print data, comprising:
a first data processing unit which generates a print data stream with print data of a plurality of print pages, at least one first object property being associated with at least one region of the print pages;
a second data processing unit that processes the print data, wherein at least one part of the at least one region of one of the plurality of print pages of the print data stream is selected;
at least one second object property differing from the first object property and which is associated with said selected part of the region on each of said plurality of print pages of the print data stream; and
the second data processing unit further processing the print data of each of said plurality of print pages which pertain to the selected part of the region dependent on the at least one second object property.

37. A system for processing of print data, comprising:
a first data processing unit in which a print data stream with print data of a plurality of print pages is generated, at least one first object property being associated with at least one region of the print pages;
a second data processing unit that processes the print data, at least one part of the region of one of the plurality of print pages of the print data stream being selected;
at least one second object property differing from the at least one first object property being associated with the selected part of the region on each of said plurality of print pages of the print data stream; and
a printer which further processes the print data of each print page that pertain to the selected part of the region dependent on the at least one second object property.

38. A system according to claim 37 wherein the second data processing unit is arranged in the printer.

39. A method for processing of print data, comprising the steps of:
generating a print data stream with print data of a plurality of print pages, first object properties being associated with at least one region of the print pages;
processing the print data wherein image data of the region are determined with which a preset graphic format is associated; and
further processing the image data dependent on the preset graphic format.

40. A method according to claim 39 wherein at least one second object property differing from the first object properties is associated with the image data dependent on the associated graphic format.

41. A method according to claim 40 wherein a second print data stream is generated in which the second object property is associated with image data of the region.

42. A method according to claim 41 wherein the second print data stream is supplied to a printer which processes the image data of the region dependent on the second object property or dependent on the at least one second object property and at least one part of the first object property, and which processes a remaining region dependent on at least one part of the first object property.

43. A method according to claim 39 wherein the region comprises the entire print page.

44. A method according to claim 39 wherein the first and/or second object property pertains to at least one output, print, and/or processing parameter.

45. A method according to claim 39 wherein at least one object property serves for selection of a color conversion method, a raster conversion method, or an error correction method.

46. A method according to claim 45 wherein the raster method is a Floyd-Steinberg raster method, a Burkes raster method, or a Stucki raster method.

47. A method according to claim 39 wherein an adaptation of a resolution of the print data contained in the print data stream to a resolution of a printer and/or an adaptation of a color and/or grey level values contained in the print data stream to device properties of the printer occurs in print preparation.

48. A method according to claim 39 wherein the region contains a plurality of data groups with which a graphic format is respectively associated, wherein image data of the respective image data group are respectively further dependent on an associated graphic format.

49. A system for processing of print data, comprising:
a first data processing unit which generates a print data stream with print data of a plurality of print pages, at least one first object property being associated with at least one region of the print pages;
a second data processing unit that processes the print data, the data processing unit determining image data of objects of the region to which a preset graphic format is assigned; and
the second data processing unit further processing the image data dependent on the preset graphic format.

50. A system according to claim 49 wherein the second data processing unit is arranged in a printer that generates a print image of the region.
